(19) United States
(12) Patent Application Publication
(10) Pub. No.: US 2022/0006483 A1
(43) Pub. Date: Jan. 6, 2022

(54) TRANSMIT/RECEIVE SWITCH CIRCUITS FOR TIME DIVISION DUPLEX COMMUNICATIONS SYSTEMS

(71) Applicant: COMMSCOPE ITALY S.R.L., Agrate Brianza, Lombardia (IT)

(72) Inventor: Corrado Luigi SCACCABAROZZI, Cassano d'Adda (IT)

(21) Appl. No.: 17/292,590

(22) PCT Filed: Feb. 5, 2020
(86) PCT No.: PCT/EP2020/052882

§ 371 Date: May 10, 2021

Related U.S. Application Data
(60) Provisional application No. 62/801,743, filed on Feb. 6, 2019.

(51) Int. Cl. H04B 1/48; H04B 1/52

(52) U.S. Cl. CPC H04B 1/48; H04B 1/52

(57) ABSTRACT

TX/RX switch circuits include an input, a first circulator having a first port coupled to the input, a circuit element having a first port coupled to a second port of the first circulator, a second circulator having a first port coupled to a second port of the circuit element, an output coupled to a second port of the second circulator, a low noise amplifier coupled between a third port of the second circulator and a third port of the first circulator, a bias circuit that is configured to set an impedance at a third port of the circuit element at a first impedance level when operating in transmit mode and to set the impedance at the third port of the circuit element to have a second impedance level when operating in receive mode, and a first PIN diode coupled between an output of the low noise amplifier and electrical ground.

### CROSS-REFERENCE TO RELATED APPLICATION

The present application claims priority to U.S. Provisional Patent Application Ser. No. 62/801,743, filed Feb. 6, 2019, the entire content of which is incorporated herein by reference.

### FIELD

The present invention relates to communications systems and, more particularly, to time division duplex communications systems.

### BACKGROUND

Cellular communications systems are well known in the art. In a typical cellular communications system, a geographic area is divided into a series of regions that are referred to as “cells,” and each cell is served by a base station. The base station may include baseband equipment, radios and antennas that are configured to provide two-way radio frequency (“RF”) communications with fixed and mobile subscribers that are positioned throughout the cell. The base station antennas generate radiation beams that are directed outwardly to serve the entire cell or a portion thereof. Typically, a base station antenna includes one or more phase-controlled arrays of radiating elements, which are commonly referred to as phased array antennas.

Conventionally, most cellular communications systems have operated as frequency division duplex (“FDD”) systems, where two-way radio communications is supported using two distinct radio channels that are at different frequencies. In an FDD system, a first channel in a first frequency band is used to transmit “downstream” communications from the base station radio to fixed and mobile subscribers throughout the cell, and a second channel that is in a second, different frequency band is used to transmit “upstream” communications from the subscribers to the base station radio. Because the downstream and upstream communications are transmitted in separate frequency bands, simultaneous transmission in both the upstream and downstream directions is possible without significant interference therebetween.

Time division duplex (“TDD”) communications systems are also known in the art. A TDD system uses a single frequency band for both downstream and upstream communications by separating the downstream and upstream communications in time. In particular, a time interval called a “frame” may be defined that is sub-divided into a plurality of smaller “time slots.” Downstream communications may be performed during some of the time slots within each frame while upstream communications may be performed in other of the time slots. Thus, a TDD communication system operates by toggling transmission directions (at high speed) over a time interval, which means that TDD can support voice and other symmetrical communication services as well as asymmetric data services such as various Internet applications, and can even support a dynamic mix of both traffic types. In addition, the relative capacity of the downstream and upstream links can be altered in favor of one direction over the other direction. This is easily accomplished by providing a greater time allocation through additional time slots to downstream (or upstream) transmission intervals relative to upstream (or downstream) transmission intervals. This asymmetric capability is useful for communication processes characterized by unbalanced information flow, such as when a relatively short upstream message prompts a large information download as is typical with Internet access.

To support two-way communications using a single frequency channel, TDD systems require a guard time interval between transmit and receive data streams, as shown in FIG. 1. This guard time interval enables a base station to switch from transmit mode to receive mode and subscribers to switch from receive mode to transmit mode, and vice versa. One or more transmit/receive (“TX/RX”) switch circuits are provided that are used to switch the base station between the transmit and receive modes. During the guard time interval, the base station and subscriber are not transmitting modulated data, as the guard time interval is provided to allow the base station transmitter (or receiver) section to ramp down, the TX/RX switch circuit to actuate, and the base station receiver (or transmitter) section to activate.

TX/RX switch circuits may be used for a variety of different functions. For example, a pair of TX/RX switch circuits may be provided that are used to route transmit path signals to a high power amplifier while routing receive path signals around the high power amplifier. A pair of TX/RX switch circuits may also be used to route receive path signals to a noise low amplifier while routing transmit path signals around the low noise amplifier. TX/RX switch circuits may similarly be used to route transmit path signals to transmit path circuit elements that adjust the amplitude and/or phase of sub-components of a transmit signal, and to route receive path signals to receive path circuit elements that adjust the amplitude and/or phase of sub-components of a received signal.

A number of TX/RX switch circuits are known in the art. For example, FIG. 2 is a high-level circuit diagram of a conventional receive channel TX/RX switch circuit 10 for a TDD communications system that selectively connects either the output of a transmitter (during transmit mode) or the input of a low noise amplifier (during receive mode) to one or more radiating elements of an antenna. As shown in FIG. 2, the TX/RX switch circuit 10 includes an input 12, an output 14, a low noise amplifier 20, a pair of 1×2 switches 30, 32, a filter 40 and a power detector 50. The input 12 may be connected to a transceiver (not shown) and the output 14 may be connected to one or more radiating elements of an antenna (not shown). As shown in FIG. 2, the input 12 is coupled to a first port 30A of switch 30, and the output 14 is coupled to a first port 32A of switch 32. The second port 30B of switch 30 is coupled to the second port 32B of switch 32, and the third port 30C of switch 30 is coupled to the third port 32C of switch 32. The low noise amplifier 20 is interposed on the path connecting the third port 30C of switch 30 to the third port 32C of switch 32. The filter 40 is coupled along the path between port 32A of switch 32 and the output 14. The power detector 50 is configured to sense a power level (or another parameter such as a current or a voltage) at port 30A of switch 30 and to provide a control signal to switches 30 and 32 based on the senses power level.

In operation, if the power detector 50 detects a power level above a preselected threshold, then the power detector 50 outputs a control signal that controls switch 30 to connect the first port 30A to the second port 30B thereof, and that controls switch 32 to connect the first port 32A to the second port 32B thereof. Alternatively, if the power detector 50 detects a power level that is below the preselected threshold, then the power detector 50 outputs a control signal that controls switch 30 to connect the first port 30A to the third port 30C thereof, and that controls switch 32 to connect the first port 32A to the third port 32C thereof. Thus, when the base station is in transmit mode, RF signals entering the TX/RX switch circuit 10 at input 12 pass from the first port 30A of switch 30 to the first port 32A of switch 32, thereby bypassing the low noise amplifier 20. Conversely, when the base station is in receive mode, RF signals entering the TX/RX switch circuit 10 at output 14 pass from the first port 32A of switch 32, through the low noise amplifier 20, to the first port 30A of switch 30.

TX/RX switch circuits are also known in the art that use circulators in place of the pair of switches included in TX/RX switch circuit 10 of FIG. 2. FIG. 3 is a high-level circuit diagram of a conventional receive channel TX/RX switch circuit 10′ that uses such circulators. As shown in FIG. 3, the TX/RX switch circuit 10′ includes an input 12, which may be connected to a transceiver (not shown), an output 14, which may be connected to one or more radiating elements of an antenna (not shown), a low noise amplifier 20, and a filter 40. These components may be identical to the identically numbered components in TX/RX switch circuit 10 described above, and hence further description thereof will be omitted. However, in TX/RX switch circuit 10′, the first and second switches 30-1, 30-2 are replaced with first and second circulators 70, 72, and the power detector 50 is omitted. When the transceiver (not shown) delivers an RF signal to be transmitted to input 12, the RF signal passes to the first port 70A of the first circulator 70. The first circulator 70 outputs the RF signal at the second port 70B thereof, and the signal then enters the first port 72A of the second circulator 72. The second circulator 72 outputs the RF signal at the second port 70B thereof, and the RF signal is then passed through the filter 40 to output 14. Thus, the low noise amplifier 20 is isolated from the transmit RF signal. When the TX/RX switch 10′ operates in receive mode, the received RF signals are passed from the output 14 to the filter 40 to the second port 72B of the second circulator 72. The second circulator 72 passes the RF signal to the third port 70C thereof, so that the RF signal is passed to the low noise amplifier 20 for amplification. The amplified received RF signal output by the low noise amplifier 20 passes to the third port 70C of the first circulator 70, which passes the signal to input 12 via the first port 70A thereof.

While FIGS. 2 and 3 illustrate TX/RX switch circuits that selectively connect a low noise amplifier along the RF transmission path, in other cases, TX/RX switch circuits may be provided that selectively connect one of a high power amplifier and a low noise amplifier along the RF transmission path. FIG. 4 is a high-level circuit diagram of an example of such a conventional TX/RX switch circuit. As can be seen, the TX/RX switch circuit 10″of FIG. 4 is identical to the TX/RX switch circuit 10 of FIG. 2, except that a high power amplifier 60 is interposed between the second port 30B of the first switch 30 and the second port 32B of the second switch 32. The circulator-based TX/RX switch circuit 10′ of FIG. 3 may similarly be modified to include a high power amplifier 60 along the RF transmission line connecting the first and second circulators 70, 72 to provide another example of a TX/RX switch circuit that selectively connects one of a high power amplifier and a low noise amplifier along the RF transmission path.

### SUMMARY

Pursuant to embodiments of the present invention, TX/RX switch circuits are provided that are suitable for use in TDD communications systems. In some embodiments, the TX/RX switch circuits may include an input, a first circulator having a first port that is coupled to the input, a circuit element having a first port that is coupled to a second port of the first circulator, a second circulator having a first port that is coupled to a second port of the circuit element, an output that is coupled to a second port of the second circulator, a low noise amplifier that is coupled between a third port of the second circulator and a third port of the first circulator, a bias circuit that is configured to set an impedance at a third port of the circuit element at a first impedance level when the TX/RX switch circuit operates in transmit mode and to set the impedance at the third port of the circuit element to have a second, different (e.g., higher) impedance level when the TX/RX switch circuit operates in receive mode, and a first PIN diode coupled between an output of the low noise amplifier and electrical ground.

In some embodiments, the first PIN diode may be configured to couple an output of the low noise amplifier to electrical ground when the TX/RX switch circuit is operating in a transmit mode. The first PIN diode may be coupled to, and controlled by, the bias circuit. In example embodiments the circuit element may be a 90° hybrid coupler. In such embodiments, the third port of the 90° hybrid coupler may be coupled to a first variable impedance circuit and a fourth port of the 90° hybrid coupler may be coupled to a second variable impedance circuit. The first and second variable impedance circuits may each comprise an impedance coupled in parallel with a PIN diode between a respective (i.e., third of fourth) port of the 90° hybrid coupler and electrical ground. An output node of the bias circuit may be coupled to the first variable impedance circuit, to the second variable impedance circuit and to the first PIN diode.

In some embodiments, the TX/RX switch circuit may further include a directional coupler having a first port coupled to the second port of the first circulator, a second port coupled to the first port of the 90° hybrid coupler, and a third port coupled to the bias circuit.

In some embodiments, the bias circuit may comprise a Schottky diode, a capacitor coupled in parallel with the Schottky diode, and an impedance coupled in parallel with the capacitor and with the Schottky diode.

In some embodiments, the TX/RX switch circuit may further include a third circulator that is interposed between the low noise amplifier and the first circulator. The third circulator may have a first port coupled to the output of the low noise amplifier, a second port coupled to the third port of the first circulator, and a third port coupled to electrical ground through a matched termination.

In some embodiments, the TX/RX switch circuit may further include a fourth circulator that is interposed between the third circulator and the first circulator. The fourth circulator may have a first port coupled to the second port of the third circulator, a second port coupled to the third port of the first circulator, and a third port coupled to electrical ground through a matched termination.

In some embodiments, the TX/RX switch circuit may further include a fourth PIN diode that is coupled between (1) an RF transmission path that connects the third port of the second circulator to an input of the low noise amplifier and (2) electrical ground.

In some embodiments, the bias circuit may be configured to set the impedances at the third and fourth ports of the circuit element based on a presence or an absence of an RF signal at the second port of the first circulator.

Pursuant to further embodiments of the present invention, TX/RX switch circuits are provided that include an input, a first circulator having a first port that is coupled to the input, a circuit element having a first port that is coupled to a second port of the first circulator, a second circulator having a first port that is coupled to a second port of the circuit element, an output that is coupled to a second port of the second circulator, a low noise amplifier having an input that is coupled to a third port of the second circulator and an output, and a third circulator having a first port that is coupled to an output of the low noise amplifier, a second port that is coupled to a third port of the first circulator, and a third port that is coupled to electrical ground through a matched termination.

Pursuant to still further embodiments of the present invention, TX/RX switch circuits are provided that include an input, a first circulator having a first port that is coupled to the input, a circuit element having a first port that is coupled to a second port of the first circulator, a second circulator having a first port that is coupled to a second port of the circuit element, an output that is coupled to a second port of the second circulator, a low noise amplifier that is coupled between a third port of the second circulator and a third port of the first circulator, and a PIN diode coupled between an RF transmission path connecting the third port of the second circulator to an input of the low noise amplifier and electrical ground.

### BRIEF DESCRIPTION OF THE DRAWINGS

FIG. 1 is a schematic diagram that illustrates how a single radio channel can be used to support two-way radio communication in a TDD communications system.

FIG. 2 is a high-level circuit diagram of a conventional receive channel TX/RX switch circuit for a TDD communications system.

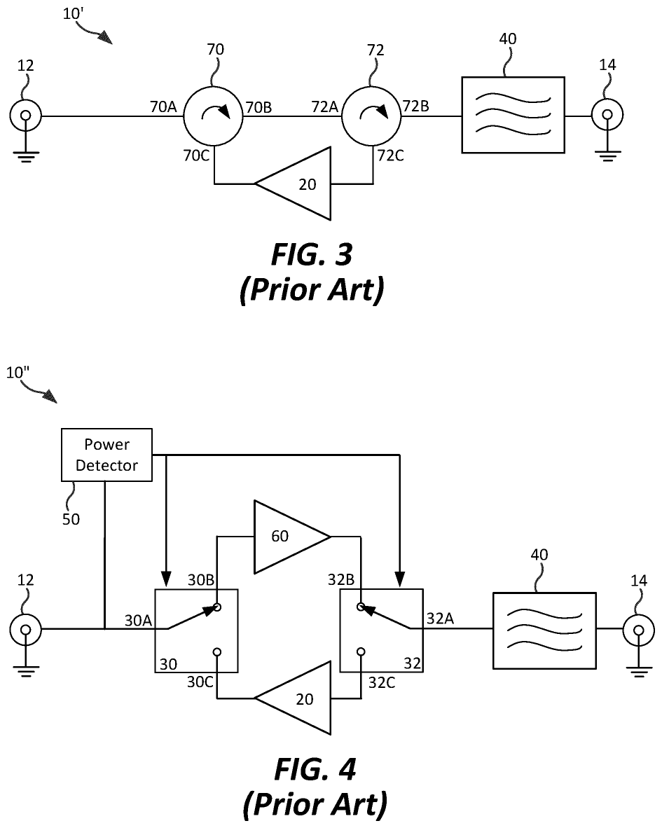

FIG. 3 is a high-level circuit diagram of another conventional receive channel TX/RX switch circuit for a TDD communications system.

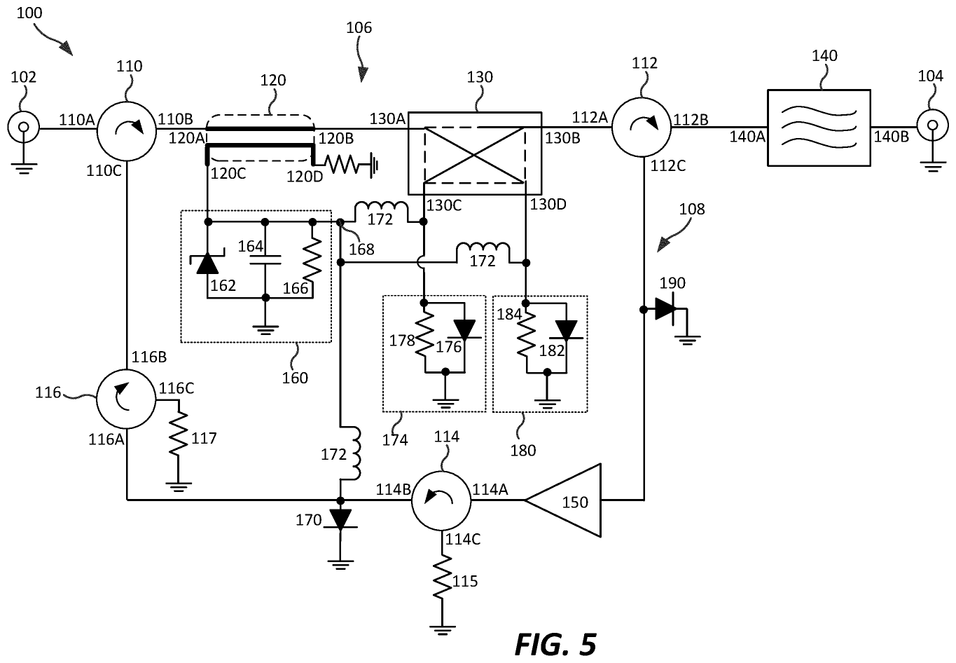

FIG. 4 is a high-level circuit diagram of a conventional TX/RX switch circuit for a TDD communications system that performs TX/RX switching for both the transmit and receive channels.

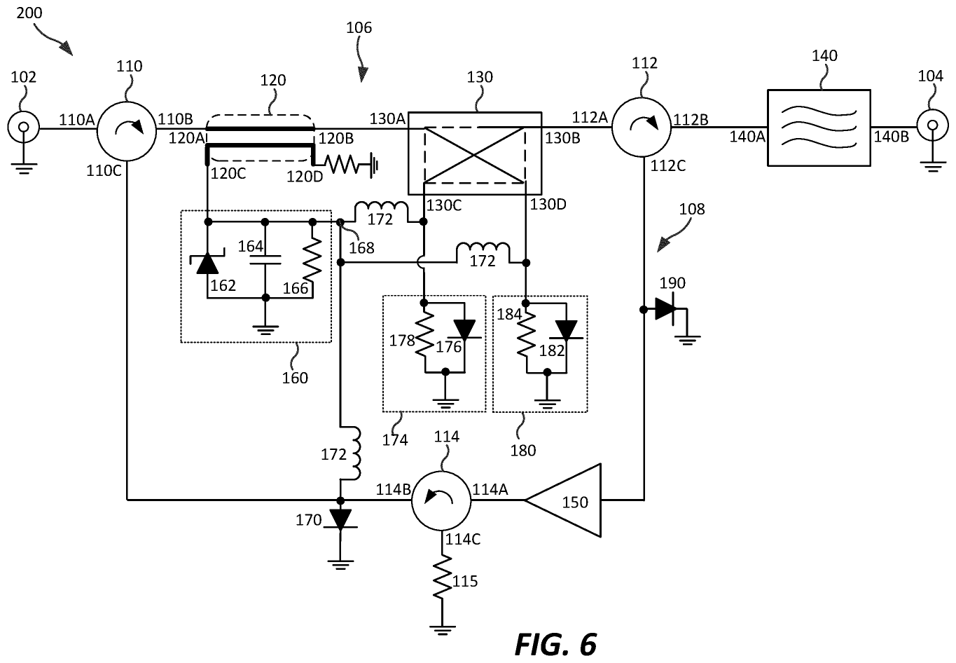

FIG. 5 is a high-level circuit diagram of a receive channel TX/RX switch circuit for a TDD communications system according to embodiments of the present invention.

FIGS. 6-8 are high-level circuit diagrams of receive channel TX/RX switch circuits for TDD communications systems according to further embodiments of the present invention.

### DETAILED DESCRIPTION

The use of TDD communications systems is increasing with the deployment of fifth generation (“5G”) cellular networks. In 5G systems, much faster switching requirements are specified as the guard bands between the transmit and receive slots in a frame have been reduced considerably. Tradeoffs exist between the speed, power handling capabilities and cost of a TX/RX switch circuit. Generally speaking, an increase in power handling capabilities increases the cost and reduces the speed of a TX/RX switch circuit. Thus, it may be a challenge to provide TX/RX switch circuits suitable for use in 5G cellular communications systems that operate at sufficiently high speeds and power handling capabilities while having reasonable cost.

Pursuant to embodiments of the present invention, TX/RX switch circuits are provided that are suitable for use in 5G cellular communications systems. The TX/RX switch circuits according to embodiments of the present invention may have fast switching speeds and sufficient power handling capabilities, and may also be relatively low cost. The TX/RX switching circuits according to embodiments of the present invention may be passive devices that use the transmit RF signals to auto-detect as the base station radio transitions between transmit and receive modes. These TX/RX switch circuits may also use the RF energy of the transmit RF signal to bias switches (e.g., PIN diodes) within the circuit that very quickly transition the circuit between its transmit mode and receive mode configurations.

The TX/RX switch circuits according to embodiments of the present invention may include first and second circulators that define a transmit path and a receive path. A circuit element such as, for example, a 90° hybrid coupler may be disposed along the transmit path, and a low noise amplifier may be disposed along the receive path. In some embodiments, the TX/RX switch circuit may further include a bias circuit that is configured to configure the circuit element to either allow or block transmissions along the transmit path. For example, when the circuit element comprises a 90° hybrid coupler, the first and second ports of the 90° hybrid coupler may be disposed along the transmit path and the bias circuit may be configured to set impedances at third and fourth ports of the 90° hybrid coupler at a first impedance level when the TX/RX switch circuit operates in transmit mode and at a second, higher impedance level (for example, a matched 50Ω impedance level) when the TX/RX switch circuit operates in receive mode. The TX/RX switch circuit may also include a first PIN diode coupled between an output of the low noise amplifier and electrical ground in some embodiments.

In other embodiments, the TX/RX switch circuits may include first and second circulators that define a transmit path that includes a circuit element and a receive path that includes both a low noise amplifier and a third circulator that is coupled at the output of the low noise amplifier. The port of the third circulator that is not along the receive path may be coupled to electrical ground through a matched termination

In still other embodiments, the TX/RX switch circuits may include first and second circulators that define a transmit path that includes a circuit element and a receive path that includes a low noise amplifier. A PIN diode may be coupled to ground along a portion of the receive path that is between the second circulator and an input of the low noise amplifier. The PIN diode may protect the low noise amplifier during a failure of components in the antenna and/or may protect the low noise amplifier from energy that may leak through the second circulator due to limited isolation.

Embodiments of the present invention will now be discussed in further detail with reference to the attached drawings.

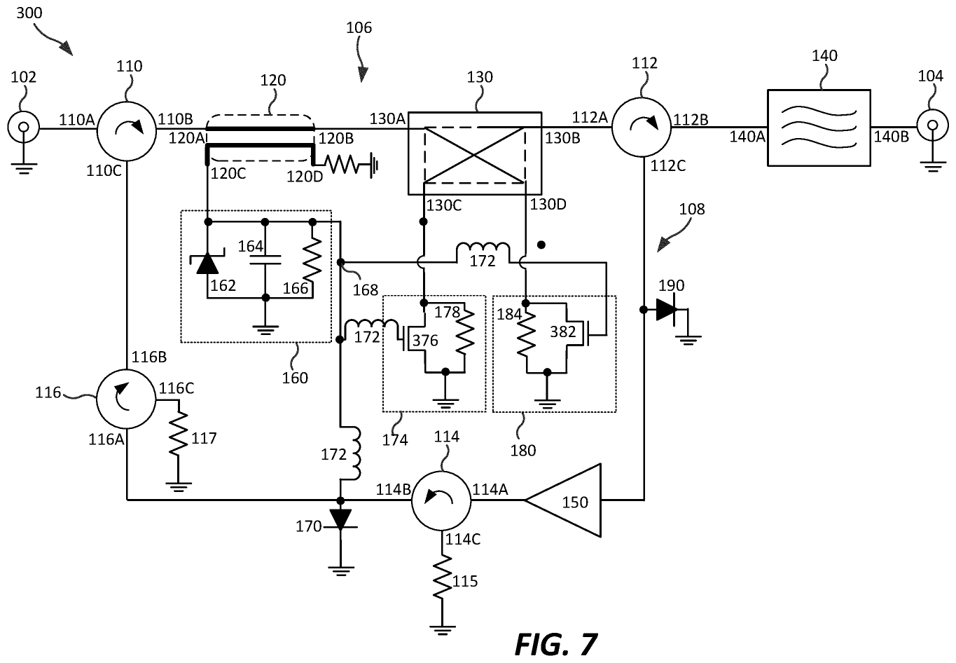

FIG. 5 is a high-level circuit diagram of a receive channel TX/RX switch circuit 100 for a TDD communications system according to embodiments of the present invention.

As shown in FIG. 5, the TX/RX switch circuit 100 includes an input 102 and an output 104. The input 102 and the output 104 may each comprise, for example, any suitable element that may pass RF signals into and out of the TX/RX switch circuit 100. By way of non-limiting examples, the input 102 and/or the output 104 may comprise an RF transmission line segment such as a microstrip RF transmission line, a stripline RF transmission line, or a coaxial cable, or may comprise an RF transmission line transition such as, for example, an airstrip to microstrip transition or a coaxial cable to microstrip transition.

The input 102 may be connected to a transceiver (not shown) and the output 104 may be connected to one or more radiating elements of an antenna (not shown). A transmit path 106 and a receive path 108 are defined between the input 102 and 104. First and second circulators 110, 112 are provided that route signals incident at input 102 to output 104 over the transmit path 106, and that route signals incident at output 104 to input 102 over the receive path 108. A directional coupler 120 and a circuit element 130 are provided along the transmit path 106 between the input 102 and the output 104. In the depicted embodiment, the circuit element 130 is a 90° hybrid coupler, although other circuit elements 130 may be used in other embodiments such as, for example, another circulator (see FIG. 8).

The first circulator 110 has a first port 110A that is coupled to the input 102, a second port 110B that is coupled to a first port 120A of the directional coupler 120, and a third port 110C that is coupled to the receive path 108. The directional coupler 120 has a second “pass through” port 120B that outputs the majority of the RF energy input at first port 120A and a third “tap” port 120C that receives a small portion of the RF energy input at first port 120A. A fourth port 120D of the directional coupler 120 may be coupled to electrical ground through a matched termination. The 90° hybrid coupler 130 is a four port device having first through fourth ports 130A through 130D. The first port 130A is coupled to the second pass through port 120B of the directional coupler 120, and the second port 130B is coupled to a first port 112A of the second circulator 112. The 90° hybrid (or other circuit element) may be configured to pass RF energy input at first port 130A when the third and fourth ports 130C, 130D are coupled to matched impedances, and configured to reflect RF energy input at first port 130A when the third and fourth ports 130C, 130D are short-circuited to electrical ground.

The second port 112B of the second circulator 112 is coupled to a first port 140A of a filter such as, for example, a bandpass filter 140. The second port 140B of the bandpass filter 140 may be coupled to the output 104. The bandpass filter 140 may be designed to pass RF signals that are within the operating frequency band of the transceiver that is coupled to input 102 and to block RF signals that are outside of the operating frequency band. The bandpass filter 140 may remove out-of-band noise that may be generated by non-linear elements within TX/RX switch circuit 100 such as the circulators and PIN diodes (discussed below) and may also remove out-of-band noise introduced external to TX/RX switch circuit 100.

The third port 112C of circulator 112 is coupled to the receive path 108. As shown in FIG. 5, the third port 112C of circulator 112 may be coupled to the input of a low noise amplifier 150. The low noise amplifier 150 may amplify RF signals input thereto to a higher signal level. The output of the low noise amplifier 150 is coupled to the first port 114A of a third circulator 114. The second port 114B of the third circulator 114 is coupled to the first port 116A of a fourth circulator 116, and the third port 114C of the third circulator 114 is coupled to ground through a termination resistor 115. The resistor 115 may form a matched termination that is impedance matched to the RF transmission lines that are connected to the first and second ports 114A, 114B of the third circulator 114. The third circulator 114 is configured to route RF energy that may be flowing in the reverse direction along the receive path 108 to ground (i.e., RF energy incident to the third circulator 114 at the second port 114B thereof is routed to electrical ground through the third port 114C and the termination resistor 115). In other words, the third circulator 114 provides additional isolation at the output of the low noise amplifier 150 to protect the low noise amplifier 150 from signals travelling in the reverse or “wrong” direction along the receive path 108. The third circulator 114 also ensures that a load is present at the output of the low noise amplifier 150 during transmit operations, as will be discussed in further detail below.

The fourth circulator 116 is coupled along the receive path 108 between the third circulator 114 and the first circulator 110. In particular, the first port 116A of the fourth circulator 116 is coupled to the second port 114B of the third circulator 114, the second port 116B of the fourth circulator 116 is coupled to the third port 110C of the first circulator 110, and the third port 116C of the fourth circulator 116 is coupled to ground through a termination resistor 117. The fourth circulator 116 is likewise configured to route RF energy that may be flowing in the reverse direction along the receive path 108 to ground (i.e., RF energy incident to the fourth circulator 116 at the second port 116B thereof is routed to electrical ground through the third port 116C and the termination resistor 117).

The switch circuit 100 further includes a bias circuit 160 that is used as a voltage and/or current source to set the state of various PIN diodes that are included in TX/RX switch circuit 100. The bias circuit 160 is coupled to the third port 120C of the directional coupler 120. In the depicted embodiment, the bias circuit 160 includes a Schottky diode 162, a capacitor 164 and a resistor 166 that are connected in parallel. An output 168 of the bias circuit 160 is coupled to first and second variable impedance circuits 174, 180 and to a PIN diode 170. Inductors 172 are provided between the output 168 of the bias circuit 160 and the first variable impedance circuit 174, the second variable impedance circuit 180 and the PIN diode 170. The inductors 172 block RF energy. The first variable impedance circuit 174 includes a PIN diode 176 that is coupled in parallel with an impedance 178 such as, for example, a 50 ohm resistor (or a resistor having another value that is set to match the impedance of the transmission line connected to the first port 130A of the 90° hybrid coupler 130). The second variable impedance circuit 180 includes a PIN diode 182 that is coupled in parallel with an impedance 184 such as, for example, a 50 ohm resistor.

The bias circuit 160 is configured so that when a high power RF signal is fed to TX/RX switch circuit 100 from the radio (typically after amplification by a high power amplifier, not shown), a high direct current (DC) voltage is generated at the output node 168 of the bias circuit 160 that is sufficient to exceed the built-in potential of the PIN diodes 176, 182 included in first and second variable impedance circuits 174, 180 and the PIN diode 170. When this occurs, the PIN didoes 170, 176, 182 become conducting.

Finally, a PIN diode 190 is coupled to the RF transmission line segment connecting the third port 112C of the second circulator 112 to the low noise amplifier 150. The PIN diode 190 acts as a low noise amplifier limiter circuit. The PIN diode 190 is configured to set an impedance at the third port 112C of the second circulator 112 so that the second circulator 112 will reflect any high power RF signals from that would otherwise enter the receive path 108 through the second port 112B of the second circulator 112. Such signals may be present in the case of an antenna failure, and the PIN diode 190 protects the low noise amplifier 150 from damage in the event of such a failure and may also protect the low noise amplifier 150 from energy that may leak through the second circulator 112 due to limited isolation within the second circulator 112.

TX/RX switch circuit 100 may operate as follows. During a transmit time slot of the TDD system, a high power RF signal is input to TX/RX switch circuit 100 through input 102. The high power RF signal passes from the input 102 to input port 110A of the first circulator 110. The first circulator 110 routes the RF signal to the second port 110B thereof and into the first port 120A of directional coupler 120. The RF signal mostly passes to the second port 120B of directional coupler 120, although a small portion of the RF energy is coupled to the tap port 120C of directional coupler 120.

The tapped RF energy passes from the third port 120C of directional coupler 120 into the bias circuit 160. Charge then builds up in the resistor-capacitor circuit 164, 166, and the circuit is configured so that the built up charge will exceed a pre-selected threshold voltage. The Schottky diode 162 is provided to bleed off excess charge. Once the voltage at the output 168 of the bias circuit 160 exceeds the pre-selected threshold voltage, the PIN diodes 176, 182 are forward biased, and the first and second variable impedance circuits 174, 180 that are coupled to the respective third and fourth ports 130C, 130D of the 90° hybrid coupler 130 appear as short circuits to ground. Under this biasing condition, all of the energy is reflected by the PIN diodes 176, 182 and the 90° hybrid coupler therefore passes RF energy incident at the first port 130A to the second port 130B thereof. When the voltage at the output 168 of the bias circuit 160 exceeds a certain threshold voltage, the PIN diode 170 also is forward biased. When this occurs, power from the bias circuit 160 may be shunted to ground through PIN diode 170. Additionally, since the forward biased PIN diode 170 provides a direct path to ground, the third circulator 114 will reflect any RF signal present at the second port 114B thereof (e.g., any RF energy that leaks through the first circulator 110 to the receive path 108 may be shunted to ground through PIN diode 170), and hence the third circulator 114 protects the low noise amplifier during transmit operations. This configuration increases the isolation between the transmit and receive paths 106, 108 when the TX/RX switch circuit 100 operates in transmit mode, improving the transmit ripple performance.

The RF signal that is output through the second port 130B of 90° hybrid coupler 130 is passed to the first port 112A of the second circulator 112. The second circulator 112 passes the RF signal to the second port 112B thereof where it is passed to the bandpass filter 140. The bandpass filter 140 filters out-of-band noise from the RF signal and passes the signal to the output 104.

When the TDD system switches to receive mode, the RF signal input at input 102 is cut off. As a result, no RF signal is passed to the directional coupler 120 and, consequently, energy is no longer coupled to the bias circuit 160. The voltage at the output 168 of the bias circuit 160 therefore drops to a low level, and the PIN diodes 176, 182 in the first and second variable impedance circuits 174, 180 are turned off (i.e., become non-conducting). Under this condition, the third and fourth ports 130C, 130D of the 90° hybrid coupler 130 see the impedance of the resistors 178, 184, respectively. As discussed above, the resistors 178, 184 may have impedances (e.g., 50Ω) that are matched to the transmission lines connected to ports 130A and 130B of the 90° hybrid coupler 130. Under these conditions, an RF signal incident at the first port 130A and at the second port 130B will be substantially absorbed by the 90° hybrid coupler 130. Consequently, any portion of the received signal that passes through the first circulator 110 and/or the second circulator 112 onto the transmit path 106 (which may occur due to the limited isolation provided by the first and second circulators 110, 112) is absorbed by resistors 178, 184. This configuration increases the isolation between the transmit and receive paths 106, 108 during receive mode, improving the ripple performance of the low noise amplifier 150, and also may help avoid auto-oscillation behavior which may otherwise occur which can result in unpredictable out-of-band impedances that degrade performance. It should also be noted that when TX/RX switch circuit 100 is operating in the receive mode, a low voltage is present at the output 168 of the bias circuit 160, which means that the PIN diode 170 is turned off and is therefore transparent to the receive path 108.

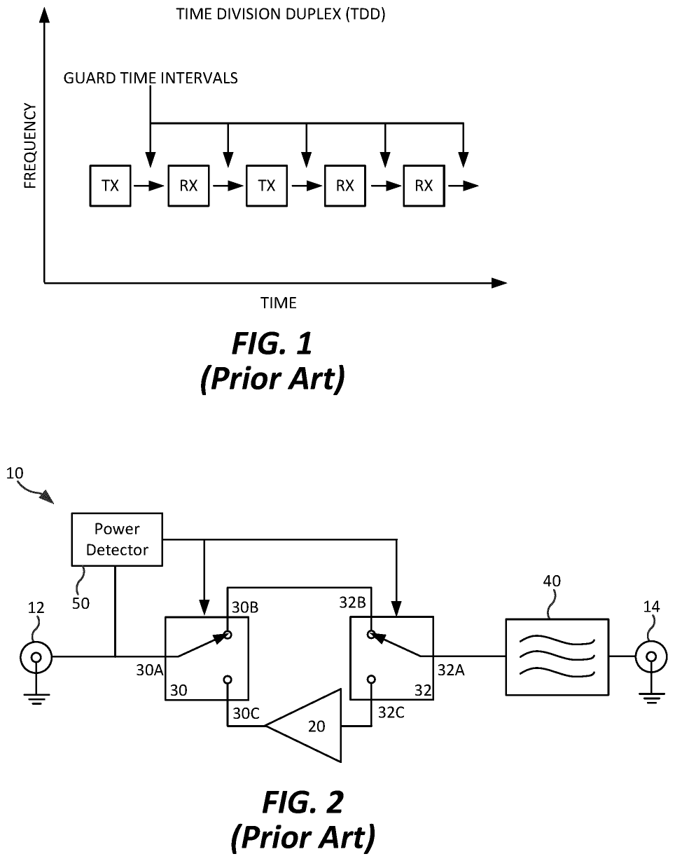

After a time interval has passed that is equal to the guard interval discussed above with reference to FIG. 1, an RF signal received by the antenna will be passed to the output 104 of switch circuit 100. This received RF signal is passed to filter 140 which filters out any out-of-band noise that may have been received and/or added in the antenna. The filtered received RF signal then enters the second circulator 112 through the second port 112B thereof, and is passed to the receive path 108 and input to the low noise amplifier 150. The low noise amplifier 150 increases the power level of the received signal, and outputs the amplified signal to the first port 114A of the third circulator 114. The signal passes through the third circulator 114 and is output at the second port 114B thereof and passed to the first port 116A of the fourth circulator 116. The signal passes through the fourth circulator 116 and is output at the second port 116B thereof and passed to the third port 110C of the first circulator 110. The received signal passes through to the first port 110A of the first circulator 110 and is passed to the input 102, where the signal may then be passed to a receiver (not shown).

As noted above, a low noise amplifier limiter circuit in the form of a PIN diode 190 is coupled to the RF transmission line segment connecting the third port 112C of the second circulator 112 to the low noise amplifier 150. The received RF signals are transparent to the PIN diode 190, and hence the PIN diode 190 is non-conducting when TX/RX switch circuit 100 is operating in receive mode. Likewise, when TX/RX switch circuit 100 is operating in transmit mode, the RF energy that leaks through the second circulator 112 onto the receive path 108 likewise will not turn on the PIN diode 190. Thus, under normal operating conditions, the PIN diode 190 remains turned off. However, if a failure occurs in the antenna, the PIN diode 190 becomes conducting and the second circulator 112 is biased to reflect RF energy incident at the second port 112B thereof back toward the 90° hybrid coupler 130 where the energy is absorbed by the resistors 178, 182. Thus, the PIN diode 190 may protect the low noise amplifier 150 from damage during certain failure conditions and may become conducting when/if the amount of transmit energy that leaks onto the receive path 108 exceeds a certain level.

The third circulator 114 ensures that a load is present at the output of the low noise amplifier 150 during transmit operations (since otherwise the output of the low noise amplifier 150 would be directly coupled to ground when the PIN diode 170 was forward biased (conducting).

The third and fourth circulators 114, 116 are provided in the switch circuit 100 in order to increase the isolation between the transmit and receive paths 106, 108. Low cost circulators may only provide a limited level of isolation which may be insufficient in some applications, particularly given the disparity in the RF signals levels that are passed along the transmit path 106 and the receive path 108. The third and fourth circulators 114, 116 provide extra isolation by passing energy that leaks through the first circulator 110 to ground. All four circulators 110, 112, 114, 116 may have the same design, although the third and fourth circulators 114, 116 may have lower power handling capabilities as only lower power signals are passed along the receive path 108.

The switch circuit 100 is a passive circuit that automatically detects transitions between transmit and receive mode by coupling a portion of any transmit RF signal to the bias circuit 160 which then automatically configures the 90° hybrid coupler 130 (or other circuit element) to either be in a pass-through or reflective state. The PIN diodes 170, 176, 182 may have very fast switching speeds, and hence TX/RX switch circuit 100 may switch very quickly between transmit and receive modes, meeting the switching speed requirements for 5G applications.

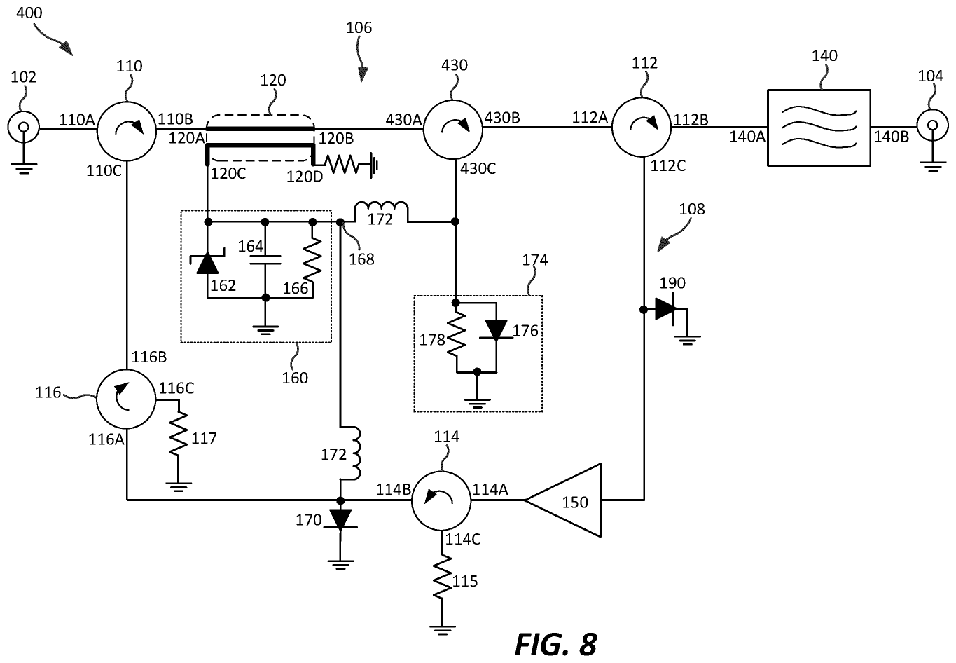

FIG. 6 is a high-level circuit diagram of a receive channel TX/RX switch circuit 200 for TDD communications systems according to further embodiments of the present invention. As shown in FIG. 6, the TX/RX switch circuit 200 is almost identical to the TX/RX switch circuit 100 of FIG. 5, with the one difference being that the fourth circulator 116 that is included in the TX/RX switch circuit 100 of FIG. 5 is omitted in the TX/RX switch circuit 200 of FIG. 6. In some cases, the extra isolation provided by the fourth circulator 116 may not be needed, and in such cases, the fourth circulator 116 may hence be omitted to reduce the cost of the TX/RX switch circuit.

FIG. 7 is a high-level circuit diagram of a receive channel TX/RX switch circuit 300 for TDD communications systems according to further embodiments of the present invention. As shown in FIG. 7, the TX/RX switch circuit 300 is very similar to the TX/RX switch circuit 100 of FIG. 5, with the difference being that PIN diodes 176 and 182 that are included in the first and second variable impedance circuits 174, 180 of TX/RX switch circuit 100 of FIG. 5 are replaced with high electron mobility transistors (“HEMTs”) 376, 382 in the TX/RX switch circuit 300 of FIG. 7. The output of the bias circuit 160 is connected to the gates of the HEMTs 376, 382 and is used to turn the HEMTs 376, 382 on or off based on whether or not a transmit RF signal is incident at the input 102 of the circuit. It will be appreciated that the PIN diodes 170 and 190 in TX/RX switch circuit may be similarly replaced with transistors in other embodiments.

FIG. 8 is a high-level circuit diagram of a receive channel TX/RX switch circuit 400 for TDD communications systems according to still further embodiments of the present invention. As shown in FIG. 8, the TX/RX switch circuit 400 is similar to the TX/RX switch circuit 100 of FIG. 5, with the difference being that the 90° hybrid coupler circuit element 130 included in the TX/RX switch circuit 100 of FIG. 5 is replaced in TX/RX circuit 400 with a fifth circulator 430. As the fifth circulator 430 is a three port device, the second variable impedance circuit 180 of TX/RX switch may also be omitted, as shown in FIG. 8. The first variable impedance circuit 174 acts to either couple the third port 430C of the fifth circulator 430 to a matched termination (i.e., resistor 178) or a short circuit to ground (through PIN diode 176) depending upon the voltage at the output 168 of the bias circuit 160, which once again is based on whether or not a transmit RF signal is incident at the input 102 of the circuit.

The switch circuits according to embodiments of the present invention may be passive circuits that do not require an external power source. The circuits may use the presence or absence of a high power RF signal at the inputs thereof as a signal to switch between transmit and receive modes, and may also use the RF energy of the transmit signals to bias PIN diodes in order to very quickly transition the switch circuit between its transmit mode and receive mode configurations.

The TX/RX switch circuits according to embodiments of the present invention may be passive circuits that are relatively low cost while providing the switching speed and performance and power handling capabilities necessary for 5G applications. The TX/RX switch circuits may auto-detect an operating mode of the base station (i.e., a transmit mode or a receive mode) by detecting the presence of an RF transmit signal and may then configure a circuit element along a transmit path of the TX/RX switch circuit to either be conductive or reflective based on the detected mode.

The present invention has been described above with reference to the accompanying drawings. The invention is not limited to the illustrated embodiments; rather, these embodiments are intended to fully and completely disclose the invention to those skilled in this art. In the drawings, like numbers refer to like elements throughout.

It will be understood that when an element is referred to as being “connected” or “coupled” to another element, it can be directly connected or coupled to the other element, or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between”, “adjacent” versus “directly adjacent”, etc.)

Spatially relative terms, such as “under”, “below”, “lower”, “over”, “upper”, “top”, “bottom” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly.

Well-known functions or constructions may not be described in detail for brevity and/or clarity. As used herein the expression “and/or” includes any and all combinations of one or more of the associated listed items.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention.

It will be understood that the above embodiments may be combined in any way to provide a plurality of additional embodiments.

1. A transmit/receive (“TX/RX”) switch circuit, comprising:
an input;
a first circulator having a first port that is coupled to the input;
a circuit element having a first port that is coupled to a second port of the first circulator;
a second circulator having a first port that is coupled to a second port of the circuit element;
an output that is coupled to a second port of the second circulator;
a low noise amplifier that is coupled between a third port of the second circulator and a third port of the first circulator;
a bias circuit that is configured to set an impedance at a third port of the circuit element at a first impedance level when the TX/RX switch circuit operates in transmit mode and to set the impedance at the third port of the circuit element to have a second, different impedance level when the TX/RX switch circuit operates in receive mode; and
a first PIN diode coupled between an output of the low noise amplifier and electrical ground.

2. The TX/RX switch circuit of claim 1, wherein the second impedance level is higher than the first impedance level.

3. The TX/RX switch circuit of claim 1, wherein the first PIN diode is configured to couple an output of the low noise amplifier to electrical ground when the TX/RX switch circuit is operating in a transmit mode.

4. The TX/RX switch circuit of claim 1, wherein the first PIN diode is coupled to the bias circuit.

5. The TX/RX switch circuit of claim 1, wherein the circuit element comprises a 90° hybrid coupler.

6. The TX/RX switch circuit of claim 5, wherein the third port of the 90° hybrid coupler is coupled to a first variable impedance circuit and a fourth port of the 90° hybrid coupler is coupled to a second variable impedance circuit.

7. The TX/RX switch circuit of claim 6, wherein the first variable impedance circuit comprises a first impedance coupled in parallel with a second PIN diode between the third port of the 90° hybrid coupler and electrical ground, and the second variable impedance circuit comprises a second impedance coupled in parallel with a third PIN diode between the fourth port of the 90° hybrid coupler and electrical ground.

8. The TX/RX switch circuit of claim 7, wherein an output node of the bias circuit is coupled to the first variable impedance circuit, to the second variable impedance circuit and to the first PIN diode.

9. The TX/RX switch circuit of claim 5, further comprising a directional coupler having a first port coupled to the second port of the first circulator, a second port coupled to the first port of the 90° hybrid coupler, and a third port coupled to the bias circuit.

10. The TX/RX switch circuit of claim 1, wherein the bias circuit comprises a Schottky diode.

11. The TX/RX switch circuit of claim 10, wherein the bias circuit further comprises a capacitor coupled in parallel with the Schottky diode and a third impedance coupled in parallel with the capacitor and with the Schottky diode.

12. The TX/RX switch circuit of claim 1, further comprising a third circulator interposed between the low noise amplifier and the first circulator, the third circulator having a first port coupled to the output of the low noise amplifier, a second port coupled to the third port of the first circulator, and a third port coupled to electrical ground through a matched termination.

13. The TX/RX switch circuit of claim 12, further comprising a fourth circulator interposed between the third circulator and the first circulator, the fourth circulator having a first port coupled to the second port of the third circulator, a second port coupled to the third port of the first circulator, and a third port coupled to electrical ground through a matched termination.

14-15. (canceled)

16. A transmit/receive (“TX/RX”) switch circuit, comprising:
an input;
a first circulator having a first port that is coupled to the input;
a circuit element having a first port that is coupled to a second port of the first circulator;
a second circulator having a first port that is coupled to a second port of the circuit element;
an output that is coupled to a second port of the second circulator;
a low noise amplifier having an input that is coupled to a third port of the second circulator and an output; and
a third circulator having a first port that is coupled to an output of the low noise amplifier, a second port that is coupled to a third port of the first circulator, and a third port that is coupled to electrical ground through a matched termination.

17. The TX/RX switch circuit of claim 16, further comprising a bias circuit that is configured to set an impedance at a third port of the circuit element at a first impedance level when the TX/RX switch circuit operates in transmit mode and to set the impedance at the third port of the circuit element to have a second, higher impedance level when the TX/RX switch circuit operates in receive mode.

18-26. (canceled)

27. A transmit/receive (“TX/RX”) switch circuit, comprising:
an input;
a first circulator having a first port that is coupled to the input;
a circuit element having a first port that is coupled to a second port of the first circulator;
a second circulator having a first port that is coupled to a second port of the circuit element;
an output that is coupled to a second port of the second circulator;
a low noise amplifier that is coupled between a third port of the second circulator and a third port of the first circulator; and
a PIN diode coupled between a radio frequency (“RF”) transmission path connecting the third port of the second circulator to an input of the low noise amplifier and electrical ground.

28. The TX/RX switch circuit of claim 27, further comprising a bias circuit that is configured to control the PIN diode.

29. (canceled)

30. The TX/RX switch circuit of claim 27, wherein the circuit element comprises a 90° hybrid coupler.

31. The TX/RX switch circuit of claim 30, wherein a third port of the 90° hybrid coupler is coupled to a first variable impedance circuit and a fourth port of the 90° hybrid coupler is coupled to a second variable impedance circuit.

32-34. (canceled)

35. The TX/RX switch circuit of claim 16, further comprising a bias circuit that is configured to set an impedance at a third port of the circuit element at a first level that is not matched to an impedance seen at the first port of the circuit element when the TX/RX switch circuit operates in transmit mode and to set the impedance at the third port of the circuit element to have a second level that is matched to the impedance seen at the first port of the circuit element when the TX/RX switch circuit operates in receive mode.
